(19) United States
(12) Patent Application Publication
(10) Pub. No.: US 2009/0114295 A1
(43) Pub. Date: May 7, 2009

(54) GAS-PANEL ASSEMBLY

(75) Inventors: Matthew L. Milburn, Felton, CA (US); Bruce C. Wier, Sunnyvale, CA (US); Sowmya Krishnan, Union City, CA (US)

Correspondence Address: King & Spalding LLP, P.O. Box 889, Belmont, CA, 94002-0889, US

(73) Assignee: ULTRA CLEAN HOLDINGS, INC., Menlo Park, CA (US)

(21) Appl. No.: 11/935,940

(22) Filed: Nov. 6, 2007

(51) Int. Cl. F16K 27/00; B21D 39/00; F16K 1/06

(52) U.S. Cl. 137/597; 228/144; 137/269

(57) ABSTRACT

A gas-panel manifold for use in a gas-panel assembly is disclosed. A manifold in the assembly provides a plurality of support surfaces, each designed for supporting a gas-component thereon, and internal passageways disposed within the manifold body for connecting gas components, with such carried on the manifold, for gas flow through the manifold in a generally downstream direction. The adjacent support surfaces in the manifold are in different planes, representing different heights above the support.

### FIELD OF THE INVENTION

The present invention relates to a gas-panel assembly, and in particular, to a gas modular gas-panel assembly having gas-component support surfaces disposed at different heights above a mounting substrate.

### BACKGROUND OF THE INVENTION

The manufacture of semiconductors involves using gases of very high purity, such as oxygen, as well as highly corrosive materials. These gases are controlled by fluid manifolds made up of valves, regulators, pressure transducers, mass flow controllers and other components that must maintain the purity of the gas, and also maintain resistance to the corrosive effects of the fluids. Currently, gas panels are used for mixing, pre-mixing, purging, sampling and venting the gases. Typically, the gas panel is used to provide a gas or a mixture of gases into a reaction chamber. These gas panels have historically been made up of hundreds of discreet or individual components, such as valves, filters, flow regulators, pressure regulators, pressure transducers, and connections. The fluid manifolds are designed to provide desired functions, such as mixing and purging, by uniquely configuring the various discreet components.

Single-block or modular-block manifold systems have been introduced into the industry in order to overcome these problems. Single-piece manifold gas-panel systems have been disclosed, for example, in U.S. Pat. Nos. 6,382,238 and 6,189,570. A gas panel composed of a plurality of modular blocks with passages routed in the blocks is described by Markulec et al. (U.S. Pat. No. 5,836,355). Modular substrate blocks which have both directional and transverse flow direction capabilities united in a single modular substrate block are described by Hollingshead (U.S. Pat. No. 6,085,783). These modular systems were typically fashioned with the entire modular block made of high purity metal required for manufacture of semiconductors. Accordingly, these block components had high manufacturing costs due to the cost of the material and the complexity of machining multiple passageways of a single block.

A modular block using different materials for the fluid passageway and the block is described in Eidsmore et al. (U.S. Pat. No. 6,629,546). In this system, the manifold system includes one or more bridge fittings that are mounted within a channel of a backing plate for structural support or in a support block. Thus, the bridge fittings are supported from beneath. Ohmi et al. (U.S. Pat. No. 6,039,360) describes a gas panel having a holding member with a U-shaped cross-section and a channel member held by the holding member. A disadvantage of these systems is that the configuration of the system cannot be modified without taking the system apart.

More recently, a gas panel assembly having separate block and pipe modular components was disclosed in co-owned U.S. Pat. Nos. 7,0148,008 and 7,213,618 for “Gas-Panel Assembly,” both of which are incorporated herein by reference. The modular gas panel assembly disclosed in these patents permits easy replacement and/or addition or removal of gas components within individual sticks, and removal of pipe modules within a stick for cleaning, replacement or reconfiguring.

### SUMMARY OF THE INVENTION

The invention includes, in one embodiment, a gas-panel manifold for use in a gas-panel assembly of the type having a manifold mounted on a base, for carrying gas through the manifold via a plurality of gas components carried on the manifold. The manifold includes a manifold body having a plurality of support surfaces, each designed for supporting a gas-component thereon, and internal passageways disposed within the manifold body for connecting gas components, with such carried on the manifold, for gas flow through the manifold in a generally downstream direction, where adjacent support surfaces in the manifold are in different planes, representing different heights above the support.

The manifold body may be formed of a plurality of manifold blocks, each providing a support surface for supporting a gas component thereon. In an exemplary embodiment, each manifold block is composed of a pair of confronting block modules, wherein each block module provides (i) at least one groove formed therein, such that when two block modules are placed together, confronting grooves in the two modules form an opening in which a portion of an internal pipe module can be received, and (ii) an upper surface region adjacent each groove, such when two block modules are placed together, confronting surface regions define a support region for supporting a collar of a pipe module having a connector received in the opening, and the internal passageways include, for each pair of adjacent blocks, a J-shaped pipe module terminating at each of its opposite ends in a collar, where the collars in a pipe module are in different planes, for providing a fluid connection between the inlet port of an upstream block in one plane to the outlet port of an adjacent downstream block in another plane.

The pipe modules, but not the block modules, may be formed of a corrosion-resistant material, such as 304 stainless steel, 316L VIM-VAR, Hastelloy™, aluminum, and ceramic, and the block modules themselves may be formed of stainless steel or aluminum.

The pipe module may have a smoothly arcuate J shape formed by a single pipe section, or a block J shape formed by three or more pipe sections joined at two or more internal welds.

The pairs of adjacent blocks forming the manifold may have the same height differentials, when mounted on the substrate, and each pipe may then have the same height differential between its two collars.

The manifold may further include a pair of spaced-apart bridging blocks, an upstream one of which provides a support surface having an outlet port and a downstream one of which provides a support surface having an inlet port, where the support surfaces of the bridging modules are the same height above the substrate in the gas-panel assembly, allowing the two modules to support opposite inlet and outlet ends of a gas component.

In another aspect, the invention includes a gas-panel assembly for use in controlling a process gas in a microfabrication system. The system includes a base, mounted on the base, a manifold composed of a manifold body having a plurality of support surfaces, each designed for supporting a gas-component thereon, and internal passageways disposed within the manifold body for connecting the gas components, with such carried on the manifold, for gas flow through the manifold in a generally downstream direction, where each pair of adjacent support surfaces in the manifold are in different planes, representing different heights above the support, and gas components mounted on the manifold support surface, with adjacent gas components being mounted at different heights with respect to the substrate. The assembly may include various manifold embodiments noted above.

Also disclosed is an improvement in a modular-block manifold of the type having a plurality of modular blocks for supporting gas components thereon, and pipe modules providing fluid passageways between adjacent blocks, where each block is composed of a pair of confronting block modules, and each block module provides (i) at least one groove formed therein, such that when two block modules are placed together, confronting grooves in the two modules form an opening in which a portion of the pipe module can be received, and (ii) an upper surface region adjacent each groove, such when two block modules are placed together, confronting surface regions define a support region for supporting a collar of the pipe module having a connector received in the opening, and the pipe modules are tubes whose opposite tube ends terminate at a collar. According to the improvement, the support surfaces of adjacent blocks forming the manifold are in different planes, representing different heights above the support, and the pipe modules are generally J-shaped, terminating at each of the opposite ends of a module in a collar, where the collars in a pipe module are in different planes, for providing a fluid connection between the inlet port of an upstream block in one plane to the outlet port of an adjacent downstream block in another plane.

As above, the pipe module may have a smoothly arcuate J shape formed by a single pipe section, or a block J shape formed by three or more pipe sections joined at two or more internal welds.

The pairs of adjacent blocks forming the manifold may have the same height differentials, when mounted on the substrate, and each pipe may then have the same height differential between its two collars.

In still another aspect, the invention includes a method of forming a pipe module terminating at each of its opposite ends in a collar. The method includes the steps of bending a straight tube into a generally J shape having a smoothly arcuate curved section and terminating at its opposite ends in different planes, before or after the bending, welding a collar to end of the tube, and after the bending, welding a collar to the other end of the tube.

These and other objects and features of the invention will be more fully understood when the following detailed description of the invention is read in conjunction with the accompanying drawings.

### BRIEF DESCRIPTION OF THE DRAWINGS

FIG. 1 shows a gas-panel assembly constructed in accordance with the invention;

FIG. 2 shows the same assembly, but with gas components in the assembly removed to show the underlying manifold of the invention;

FIG. 3 shows three adjacent modular blocks in the manifold of the invention and connecting pipe modules, with the components in disassembled form;

FIG. 4 shows the three adjacent modular blocks and pipe modules of FIG. 3 in assembled form;

FIG. 5 shows a first embodiment of pipe modules employed in the manifold in FIG. 2;

FIG. 6 shows a second embodiment of pipe modules employed in the manifold in FIG. 2; and

FIGS. 7A-7E illustrate steps in constructing a pipe module of the type shown in the FIG. 5 pipe configuration.

### DETAILED DESCRIPTION OF THE INVENTION

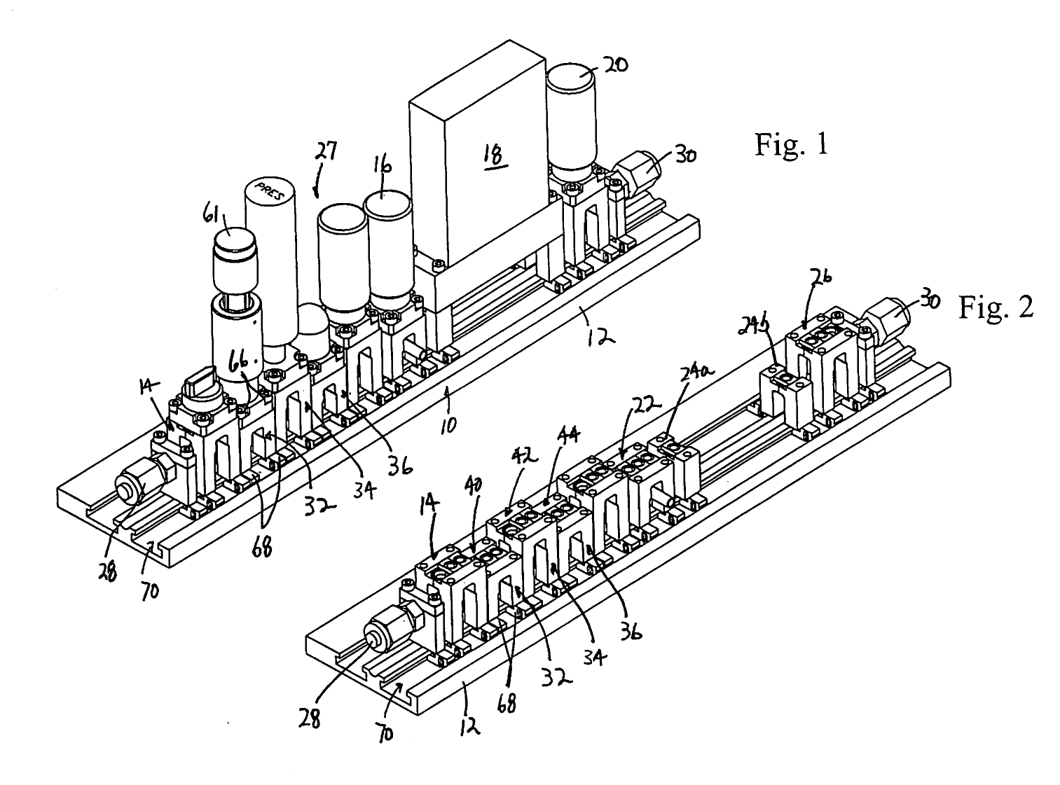

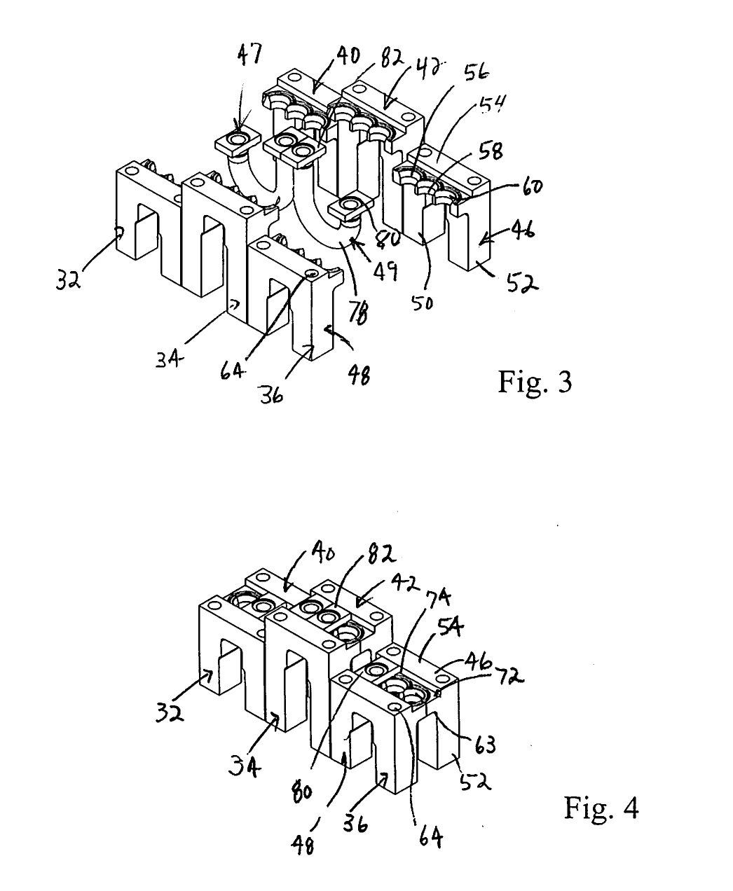

FIG. 1 shows, in perspective view, a gas-panel assembly 10 constructed in accordance with the invention. The assembly generally includes a base or support 12 supporting thereon, a manifold 14 and a plurality of gas components, such as components 16, 18, 20, mounted on support surfaces of the manifold, such as support surfaces 22, 24a and 24b, and 26 of FIG. 2, respectively. The manifold and associated gas components are referred to herein collectively as a gas-panel stick 27, and this stick functions to carry a processing gas from a gas source (not shown) to an inlet 28, from which the gas travels in an upstream-to-downstream direction (left-to-right in the figures) through the stick, passing through the various gas components, such as components 16, 18, 20 and through internal fluid passageways in the manifold (to be described below) connecting the adjacent gas components to one another. The gas components may include valves, flow regulators, pressure regulators, pressure indicators/transducers, and filters. For example, gas component 18 in the figure is a mass flow controller. Although only one gas stick is shown in the figure, a gas-panel assembly will typically include two or more such sticks, each carrying a separate process gas which is then mixed, at a desired gas ratio, at the downstream end of the assembly, e.g., at gas outlet 30. The adjacent sticks in an assembly may be connected to one another at certain gas flow intersections, as described below with respect to FIGS. 3 and 4.

In the embodiment shown in FIGS. 1 and 2, the manifold is composed of a plurality of modular blocks, such as blocks 32, 34, 36. In another general embodiment, the manifold is formed as a single, unitary piece. In both embodiment, the manifold provides a plurality of support surfaces, such as surfaces 40, 42, 44 in blocks 32, 34, 36, respectively, for supporting individual gas components thereon, as noted above (FIGS. 2, 3, and 4). Also in both general embodiments, and in accordance with the invention, adjacent support surfaces in the manifold, such as support surface 40, 42, 44, are in different planes, representing different heights above the support base. Likewise, gas components supported on the manifold are mounted at different heights on the manifold. Where the manifold is formed as a single unitary piece, the fluid passageways may be provided by internal conduits formed in the manifold body, e.g., by drilling, yielding V-shaped passageways having unequal-length arms. Where the manifold is formed of individual manifold blocks, the fluid passageways may be provided by individual pipe modules connecting adjacent blocks as detailed below with respect to FIGS. 3 and 4.

FIGS. 3 and 4 illustrate the construction of modular blocks 32, 34, 36, a pipe module 47 connecting a surface of block 32 to a surface of block 34, and a pipe module 49 connecting a surface of block 34 to a surface of block 36. As seen best in FIG. 3, each modular block is composed of a pair of block modules, such as block modules 46, 48 in modular block 36. Block module 46, which is representative, has the general shape of an inverted U formed of a pair of supporting legs 50, 52 and an upper bridge 54 spanning the legs. Each block module has one or more semi-circular grooves or cutouts, such as grooves 56, 58, 60 in module 46, such that when two block modules are placed together, opposing grooves in the block modules each form a cylindrical opening, such as opening 63 in modular block 36, as seen best in FIG. 4. Each block module also includes a pair of vertical holes or channels, such as hole 64, in block module 48, used for mounting the modular blocks on support 12. As can be appreciated from FIG. 1, each modular block and the gas components carried on the block, such as gas component 61 carried on modular block 32, are mounted on support 12 by four fastening bolts, such as bolts 66, which extend through bolt holes in the gas component, and the bolt holes in the modular block, and threadedly engage mounting brackets, such as brackets 68 carried in channel, such as channel 70, formed in the base 12. As can be appreciated, tightening the fastening bolts into the brackets secures the gas component and modular block to the base by forcing the brackets against the overhang forming each channel in the base.

The central upper surface of each block module is notched along its lengths, such when two block modules are placed together, their upper surfaces form a rectangular channel, such as channel 72 formed in block 36, as seen in FIG. 4. As will be seen below, this channel forms a support surface, such as surface 74 in channel 72, for supporting rectangular collars of the pipe module(s) whose pipe connectors are received in the associated opening formed by the block modules. This can be seen in FIG. 3 and 4, which shows a collar 80 in pipe module 49 received in the central opening formed by the two block modules, and whose collar is supported on surface 74 within the rectangular channel formed by the two block modules. Thus, in an assembled manifold, each pipe module is supported at its opposite end connectors (and optionally, at internal connectors if the pipe module contains more than two gas ports) by its two or more pipe-module collars resting on two or more support surface formed by confronting pairs of block modules. Typically, a pipe module is contained within and supported by two or more different modular blocks.

As can be appreciated from FIGS. 1-4, alternating modular blocks forming the manifold have their upper support surfaces in different horizontal planes, representing different heights above the surface of base 12. In the particular embodiment shown, every other block is in one plane, and is interspersed by blocks which all have their support surfaces in a second plane. It is noted that the modular block supporting gas component (mass controller) 18 consists of two one-port blocks 24a, 24b, both having their upper support surface in the lower of the two planes containing the blocks' support surfaces, and act as bridge supports for opposite sides of the gas component mounted on the block. Similarly, in a gas-panel assembly having more than one gas stick, each stick manifold may include additional modular blocks, each at the same of different heights, for joining gas flow across adjacent sticks. Where the modular blocks in the two adjacent sticks have their support surfaces in the same plane, the connecting pipe modules may be internal or external (above-surface) U-shaped pipe modules whose ports and collars lie in the same plane, as disclosed, for example, in U.S. published application 20060272721 for “Gas-Panel Assembly,” which is incorporated herein by reference. Where the modular blocks in the two adjacent sticks have their support surfaces in different planes, the connecting pipe modules may be internal or external (above-surface) J-shaped pipe modules of the type described herein. In both case, for external pipe modules, the module is oriented with its collars facing down.

With reference particularly to FIGS. 3, 5, and 7E, pipe module 49, which is representative, is formed of a single pipe section 78 module having a smoothly arcuate J shape and a pair of collars 80, 82 that are welded to the ends of the pipe section as described below. Although not seen in the figures, the lower sides of the collars may have arcuate ridges on opposite sides of the collar that engage an arcuate (e.g., circular) groove formed about the opening in the support surface of each modular block, such that each pipe-module collar serves to engage opposite side of the opening, acting to hold the top surfaces in the two block modules forming a modular block together, as force is applied to this upper surface in securing the gas component and block to base 12. This collar construction is described in co-owned U.S. Pat. No. 7,213,618, which is incorporated herein by reference.

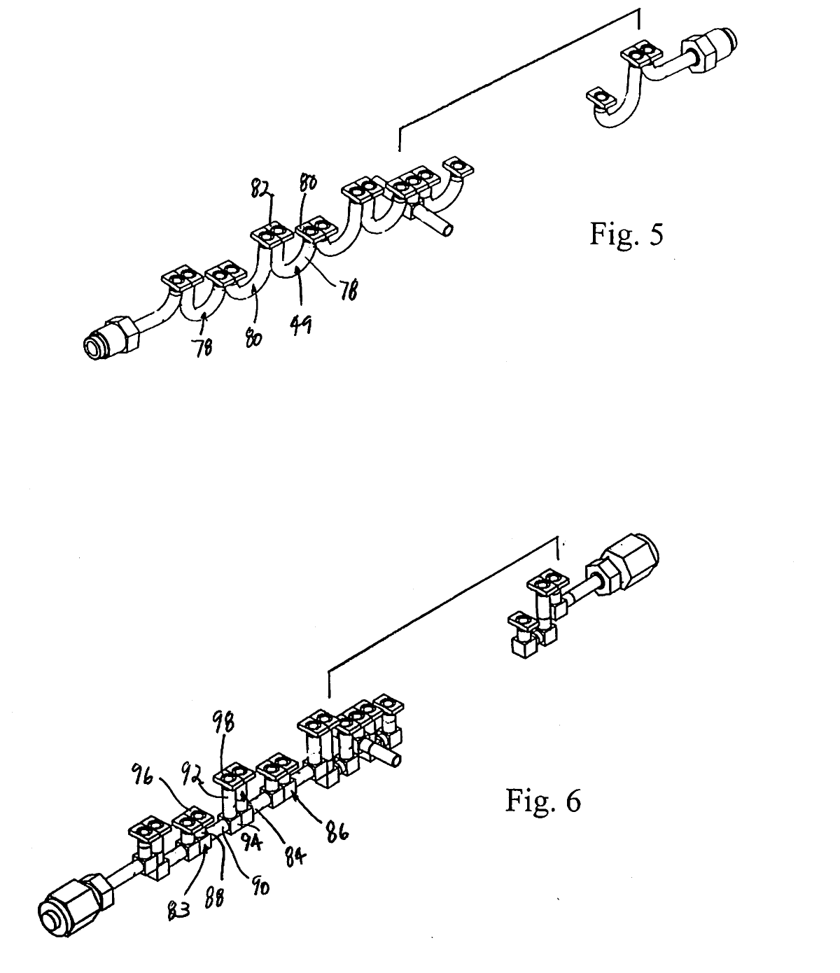

The arrangement of pipe modules seen in FIG. 5 is that which the modules would have in manifold 14 seen in FIGS. 1 and 2. In particular, each J-shaped module, such as module 78, 80, is oriented so that its collars, which lie is different horizontal planes in the assembled manifold, have the same lower-to-higher or higher-to-lower orientation as the corresponding heights of the adjacent modular blocks that the pipe module connects. Thus, for example, pipe module 49 in FIG. 3 connects block 34, whose support surface lies in a plane one plane to block 36 whose support surface lies in a lower plane. Thus, the J-orientation of the pipe modules is alternately reversed, as seen in FIGS. 3 and 5. An advantage of this construction is that the manifold can be constructed with only two different types of modular blocks and a single J-shaped pipe module.

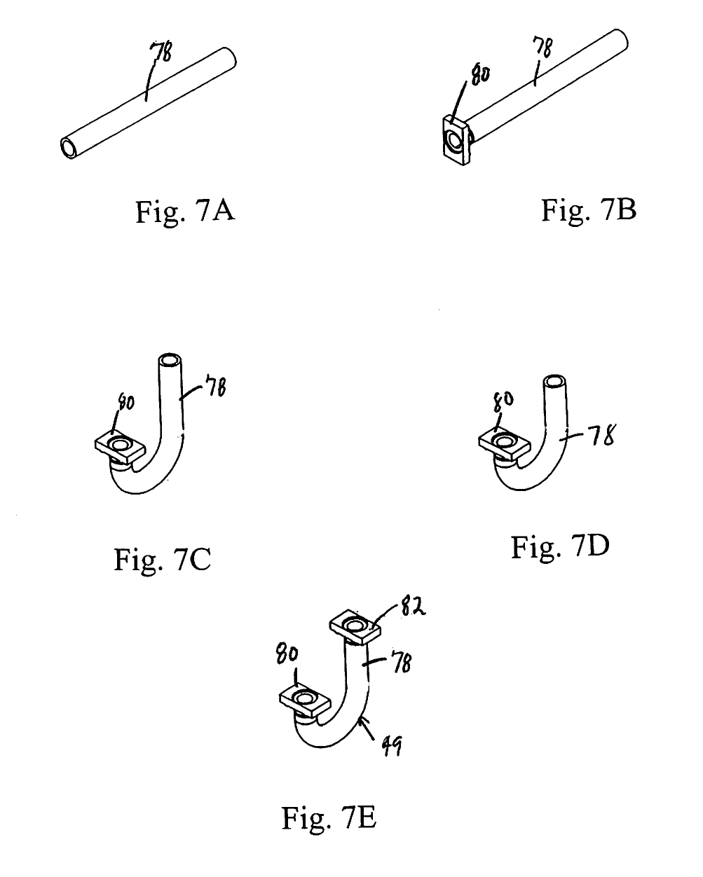

The method of constructing a smoothly arcuate pipe module, such as module 49 is illustrated in FIGS. 7A-7B. Initially, a straight pipe section 78 (FIG. 7A) is prepared at end for welding, and a collar 80 of the type described above is welded to that end, as seen in FIG. 7B. Where the pipe module is designed to carry corrosive processing gases, as is common in gas panels of this type, the pipe section and collars used in pipe module construction are preferably formed of a high-quality corrosion-resistant metal or metal alloy, such as 316L VIM-VAR or an alloy such as Hastelloy™ (available from Haynes International). As can be appreciated, one advantage of the modular block manifold construction is that only the pipe modules need to be formed of the corrosion-resistant material, while the block modules forming the modular blocks may be formed of a less expensive, less corrosion-resistant material, such as stainless steel, aluminum, or a high-strength plastic.

The pipe section with attached collar is then shaped to have the smoothly arcuate semi-circular bend seen in FIG. 7C. This may be accomplished by a number of standard procedures known to those skilled in the art, for example, using close-fitting dies on the inside and outside of the bend that reduce the amount of oval that the tube can assume during bending, using a straight follower die inside the tube itself that is pulled out as the tube is bent around, and using a solid filler material inside the tube during bending, reducing the ability of the tube to collapse during bending. Once the bend is finished, as shown in FIG. 7D, the upper end of the pipe is cut to a desired height, the cut end prepared for welding, and second collar 82 then welded to this end, to produce the finished pipe module seen in FIG. 7E. One advantage of this J-tube construction is that collar 80 in the lower plane of the module does not interfere with the welding of collar 82 to the pipe module in a substantially different plane.

FIG. 6 shows an arrangement of pipe modules, such as modules 83, 84, 86, like the arrangement shown in FIG. 5, but where the pipe modules have a block construction rather than the smoothly arcuate pipe-module construction described above. As seen, each pipe module, such as module 83, is constructed of three pipe sections, such as sections 88, 90, 92, where the pipe sections are joined by welding to conventional square joints, such as joint 94 joining sections 90, 92, and terminate at their open ends at collars, such as collars 96, 98 which occupy different planes corresponding to the two support surface planes occupied by the modular blocks in the manifold. The collars in the block-construction pipe modules may have lower-surface ridges, as discussed above, for mating with corresponding grooves in the upper surfaces of the modular blocks, to help stabilize the blocks in the assembled gas panel. The pipe modules are preferably formed of corrosion-resistant pipe, joint, and collar components as discussed above with respect to FIGS. 5 and 7.

From the forgoing, it will be appreciated how various objects and features of the invention are met. The different-height support surfaces in the manifold allow more gas components requiring more frequent cleaning or replacement to be located on an “elevated” support surface, for easier removal and replacement. Further, as noted with respect to FIG. 7D, the welding of a second collar to the pipe module is simplified by having the two collars in separate planes.

Although the invention has been described with respect to particular embodiments and applications, it will be appreciated that various changes and modifications may be made without departing from the invention. For example, although the manifold support surfaces in the embodiment described lie in one of two planes (not counting the third plane occupied by the MFC support), support surfaces may occupy three of more distinct planes. Even in a modular-block manifold, a multiple-plane embodiment is consistent with a single J-shaped pipe module, as long as the height differential between support surfaces in adjacent blocks corresponds to that of the pipe module.

It is claimed:

1. A gas-panel manifold for use in a gas-panel assembly of the type having a manifold mounted on a base, for carrying gas through the manifold via a plurality of gas components carried on the manifold, said manifold comprising
a manifold body having a plurality of support surfaces, each designed for supporting a gas-component thereon, and
internal passageways disposed within said manifold body for connecting gas components, with such carried on the manifold, for gas flow through the manifold in a generally downstream direction,
where adjacent support surfaces in the manifold are in different planes, representing different heights above the support.

2. The manifold of claim 1, wherein said manifold body is formed of a plurality of manifold blocks, each providing a support surface for supporting a gas component thereon.

3. The manifold of claim 2, wherein each manifold block is composed of a pair of confronting block modules, wherein each block module provides:
(i) at least one groove formed therein, such that when two block modules are placed together, confronting grooves in the two modules form an opening in which a portion of an internal pipe module can be received, and (ii) an upper surface region adjacent each groove, such when two block modules are placed together, confronting surface regions define a support region for supporting a collar of a pipe module having a connector received in said opening, and
said internal passageways include, for each pair of adjacent blocks, a J-shaped pipe module terminating at each of its opposite ends in a collar, where the collars in a pipe module are in different planes, for providing a fluid connection between the inlet port of an upstream block in one plane to the outlet port of an adjacent downstream block in another plane.

4. The manifold of 3, wherein said pipe modules, but not said block modules, are formed of a corrosion-resistant material.

5. The manifold claim 4, wherein said pipe modules are formed of a material selected from the group consisting of 304 stainless steel, 316L VIM-VAR, Hastelloy™, aluminum, and ceramic, and said block modules are formed of a material selected from the group consisting of stainless steel and aluminum.

6. The manifold of claim 3, wherein said pipe module has a smoothly arcuate J shape formed by a single pipe section.

7. The manifold of claim 3 wherein said pipe module has a block J shape formed by three pipe sections joined at two internal welds.

8. The manifold of claim 3, wherein pairs of adjacent blocks forming the manifold have the same height differentials, when mounted on said substrate, and each of the pipe modules has the same height differential between its two collars.

9. The manifold of claim 3, which further includes a pair of spaced-apart bridging blocks, an upstream one of which provides a support surface having an outlet port and a downstream one of which provides a support surface having an inlet port, where the support surfaces of the bridging modules are the same height above the substrate in the gas-panel assembly, allowing the two modules to support opposite inlet and outlet ends of a gas component.

10. A gas-panel assembly for use in controlling a process gas in a microfabrication system, comprising
a base,
mounted on said base, a manifold composed of a manifold body having a plurality of support surfaces, each designed for supporting a gas-component thereon, and internal passageways disposed within said manifold body for connecting the gas components, with such carried on the manifold, for gas flow through the manifold in a generally downstream direction, where each pair of adjacent support surfaces in the manifold are in different planes, representing different heights above the support, and
gas components mounted on the manifold support surface, with adjacent gas components being mounted at different heights with respect to the substrate.

11. The assembly of claim 1, wherein said manifold body is formed of a plurality of manifold blocks, each providing a support surface for supporting a gas component thereon.

12. The assembly of claim 11, wherein each manifold block is composed of a pair of confronting block modules, wherein each block module provides:
(i) at least one groove formed therein, such that when two block modules are placed together, confronting grooves in the two modules form an opening in which a portion of an internal pipe module can be received, and
(ii) an upper surface region adjacent each groove, such when two block modules are placed together, confronting surface regions define a support region for supporting a collar of a pipe module having a connector received in said opening, and the internal, and
said internal passageways include, for each pair of adjacent blocks, a J-shaped pipe module terminating at each of its opposite ends in a collar, where the collars in a pipe module are in different planes, for providing a fluid connection between the inlet port of an upstream block in one plane to the outlet port of an adjacent downstream block in another plane.

13. The assembly of claim 12, wherein said pipe module has a smoothly arcuate J shape formed by a single pipe section.

14. The assembly of claim 12, wherein said pipe module has a block J shape formed by three pipe sections joined at two internal welds.

15. The assembly of claim 12, wherein pairs of adjacent blocks forming the manifold have the same height differentials, when mounted on said substrate, and each of the pipe modules has the same height differential between its two collars.

16. The assembly of claim 12, which further includes a pair of spaced-apart bridging blocks, an upstream one of which provides a support surface having an outlet port and a downstream one of which provides a support surface having an inlet port, where the support surfaces of the bridging modules are the same height above the substrate in the gas-panel assembly, allowing the two modules to support opposite inlet and outlet ends of a gas component.

17. In a modular-block manifold comprising a plurality of modular blocks for supporting gas components thereon, and pipe modules providing fluid passageways between adjacent blocks, where each block is composed of a pair of confronting block modules, and each block module provides (i) at least one groove formed therein, such that when two block modules are placed together, confronting grooves in the two modules form an opening in which a portion of the pipe module can be received, and (ii) an upper surface region adjacent each groove, such when two block modules are placed together, confronting surface regions define a support region for supporting a collar of the pipe module having a connector received in said opening, and the pipe modules are tubes whose opposite tube ends terminate at a collar, an improvement in which
the support surfaces of adjacent blocks forming the manifold are in different planes, representing different heights above the support, and
the pipe modules are generally J-shaped, terminating at each of its opposite ends in a collar, where the collars in a pipe module are in different planes, for providing a fluid connection between the inlet port of an upstream block in one plane to the outlet port of an adjacent downstream block in another plane.

18. The improvement of claim 17, wherein said pipe modules have a smoothly arcuate J shape formed by a single pipe section.

19. The improvement of claim 17, wherein said pipe modules have a block J shape formed by three pipe sections joined at two internal welds.

20. The improvement of claim 17, wherein pairs of adjacent blocks forming the manifold have the same height differentials, when mounted on said substrate, and each of the pipe modules has the same height differential between its two collars.

21. A method of forming a pipe module terminating at each of its opposite ends in a collar, comprising
bending a straight tube into a generally J shape having a smoothly arcuate shape and terminating at its opposite ends in different planes,
before or after said bending, welding a collar to end of the tube, and
after said bending, welding a collar to the other end of the tube.
